(19) United States
(12) Patent Application Publication
(10) Pub. No.: US 2007/0061461 A1
(43) Pub. Date: Mar. 15, 2007

(54) Computer-implemented method, system, and program product for resource forecasting in an information technology (IT) migration

(75) Inventors: Scott D. Hicks, Underhill Center, VT (US); James A. Martin JR., Endicott, NY (US); Jamie P. Rigoni, Fairfax, VT (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/226,096

(22) Filed: Sep. 14, 2005

(51) Int. Cl. G06F 15/173

(52) U.S. Cl. 709/226

(57) ABSTRACT

The present invention provides a computer-implemented method, system, and program product for forecasting the availability of resources in an information technology (IT) migration. More specifically, under the present invention, an IT migration schedule is received and a future availability of a resource is forecasted from the migration schedule. The forecast period may be user-defined. In addition, under the present invention, the migration schedule received may be altered based on the forecasted resource availability.

### BACKGROUND OF THE INVENTION

1. Field of the Invention

The present invention generally relates to Information Technology (IT) migrations. Specifically, the present invention provides a method, system, and program product for forecasting the availability of resources in an IT migration.

2. Related Art

As Information Technology (IT) continues to advance, many organizations are faced with the task of migrating their existing computer infrastructures, telephone systems and the like to newer technology. For example, an organization might wish to migrate its networking functions from token ring to Ethernet. Similarly, an organization might wish to migrate its telephone service from landline-based service to voice-over-IP service.

An IT migration can involve not only adding components such as hardware or software, but can also involve the physical relocation of existing individuals, devices, and/or components. To this extent, there is often the need to provide accurate forecasting of the need for and availability of resources associated with the IT migration. That is, project staff performing or assisting with the migration need to be know what resources will be required for future stages of the IT migration and whether or not those resources will be available. Migration schedules may be made or adjusted in response to such forecasts of resource requirements and availabilities.

No matter what form a migration schedule takes, the project management team needs to match the available labor resources with the devices to be migrated and develop the migration schedule. Many factors come into play, such as: the availability of component parts; the type of device being migrated; software that may be running on the device (e.g., the operating system, if the device is a computer); the location of the device; the availability of the owner (if the owner needs to be present for any reason); an available time window for critical devices that have restrictions on their down time; the network connectivity (e.g., which network infrastructure devices in which closet serves the device); environmental conditions (e.g., there may be heavy furniture that is blocking a network or telephone port or there may be modifications required to the workspace to accommodate a new piece of equipment); the availability of team members with specific skills needed for particular devices, such as printers or machines running UNIX; etc.

Heretofore, these migration scheduling activities have been done using a plurality of disparate resources such as spreadsheets, calendars, whiteboards, or scheduling programs on PCs. Matching up the resources with thousands of devices can be a daunting task that takes hours of planning and is prone to error. The unavailability of resources when needed may cause delays in the migration schedule. In addition, knowing whether particular resources will be available at specified times in the future permits more realistic schedules that are less prone to such delays.

In view of the foregoing there exists a need for a tool that permits accurate forecasting of the availability of resources related to a migration schedule.

### SUMMARY OF THE INVENTION

In general, the present invention provides a computer-implemented method, system, and program product for forecasting the availability of resources in an information technology (IT) migration. More specifically, under the present invention, an IT migration schedule is received and a future availability of a resource is forecasted from the migration schedule. The forecast period may be user-defined. In addition, under the present invention, the migration schedule received may be altered based on the forecasted resource availability.

A first aspect of the invention provides a computer-implemented method for forecasting availability of a resource in an Information Technology (IT) migration, comprising: receiving a schedule to perform the IT migration; and forecasting a future availability of a resource during a forecast period.

A second aspect of the invention provides a system for forecasting availability of a resource in an Information Technology (IT) migration, comprising: means for receiving a schedule to perform the IT migration; means for forecasting a future availability of a resource during a forecast period; means for generating a view of a forecasted future availability; and means for amending the schedule based on the forecasted future availability.

A third aspect of the invention provides a program product stored on a computer-readable medium for forecasting availability of a resource in an Information Technology (IT) migration, the computer readable medium comprising program code for causing a computer system to perform the following steps: receiving a schedule to perform the IT migration; and forecasting a future availability of a resource during a forecast period.

A fourth aspect of the invention provides a method for deploying an application for forecasting availability of a resource in an Information Technology (IT) migration, comprising: providing a computer infrastructure being operable to: receive a schedule to perform the IT migration; and forecast a future availability of a resource during a forecast period.

A fifth aspect of the invention provides computer software embodied in a propagated signal for availability of a resource in an Information Technology (IT) migration, the computer software comprising instructions for causing a computer system to perform the following functions: receive a schedule to perform the IT migration; and forecast a future availability of a resource during a forecast period.

A sixth aspect of the invention provides a business method for forecasting availability of a resource in an information technology (IT) migration, the business method comprising managing a computer infrastructure that performs each of the steps of the invention; and receiving payment based on the managing step.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative embodiment of a system of the present invention.

FIG. 2 shows an illustrative view of a resource availability forecast according to the present invention.

FIG. 3 shows an alternative illustrative view of a resource availability forecast according to the present invention.

FIG. 4 shows a method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As noted above, the present invention provides a computer-implemented method, system, and program product for forecasting the availability of resources in an information technology (IT) migration. More specifically, under the present invention, an IT migration schedule is received and a future availability of a resource is forecasted from the migration schedule. The forecast period may be user-defined. In addition, under the present invention, the migration schedule received may be altered based on the forecasted resource availability.

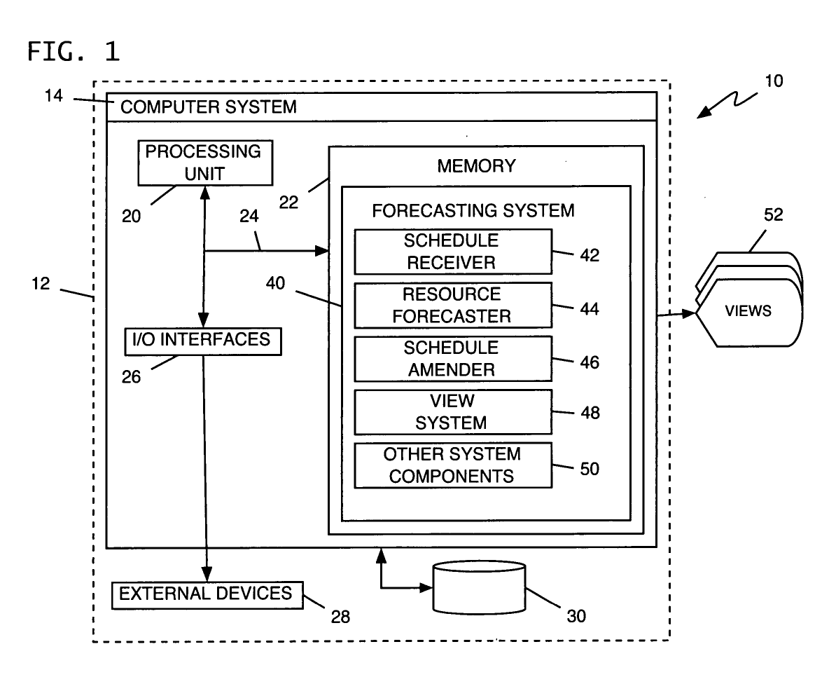

Referring now to FIG. 1, a system 10 for forecasting availability of a resource in an IT migration according to the present invention is shown. Specifically, FIG. 1 depicts a system 10 in which information for an IT migration (migration information) can be centrally stored, managed, used to forecast resource availability, and, optionally, amend a migration schedule on an on-demand basis. In addition, system 10 allows electronic views 52 containing the migration and/or forecast information to be generated and displayed. As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to forecast resource availability in an IT migration.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as forecasting system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention, such as migration information, schedules, inventories of IT resources, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is forecasting system 40, which is a software program that will provide the functions of the present invention, and which includes a schedule receiver 42, a resource forecaster 44, a schedule amender 46, and a view system 48. In addition, forecasting system 40 may include other system components 50, such as messaging systems, migration scheduling systems, migration management systems, etc.

Various pieces of migration information could be needed to properly plan and carry out an IT migration. Such information can include, for example, the type of device being migrated; software that may be running on the device (e.g., the operating system, if the device is a computer); the location of the device; the availability of the owner (if the owner needs to be present for any reason); components (e.g., hardware and software components) needed for the IT migration; an available time window for critical devices that have restrictions on their down time; the network connectivity (e.g., which network infrastructure devices in which closet serves the device); environmental conditions (e.g., there may be heavy furniture that is blocking a network or telephone port or there may be modifications required to the workspace to accommodate a new piece of equipment); the availability of team members with specific skills needed for particular devices, such as printers or machines running UNIX.; etc.

In previous systems such information was generally collected and stored in a variety of disparate systems, with significant manual efforts required. Such an arrangement makes forecasting the availability of migration resources difficult. In addition, such difficulties are on-going, as forecasts, to ensure accuracy, generally change during the IT migration process as schedules and resources change. Under the present invention, all migration information (such as the above) relevant to forecasting resource availability will be received by schedule receiver 42 and, optionally, stored in storage system 30. Using this information, resource forecaster 44 will generate a forecast of resources available for the IT migration in one or more time periods. Time periods may be user-defined or pre-defined. In either case, time periods may be static (e.g., defined by a particular date or a range of dates) or relative (e.g., a number of days, weeks, months, etc. from the current date). The forecast for each time period may be based on any number of factors, such as the number and types of devices scheduled for migration, the number and types of devices projected to be migrated, current and projected inventories of resources (e.g., component parts, necessary equipment, personnel), etc.

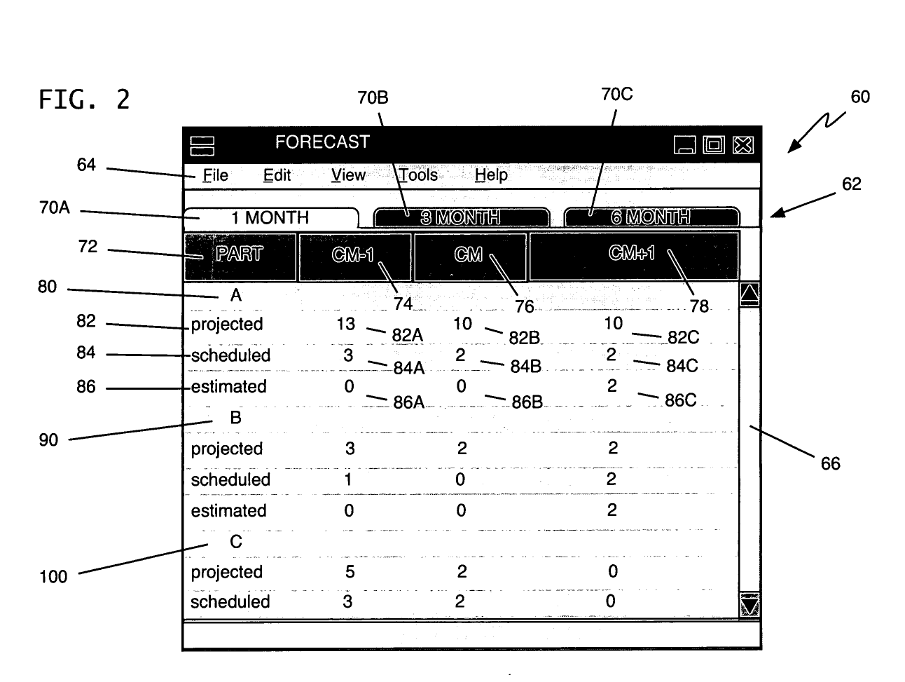

View system 48 can generate and display a set (e.g., one or more) of electronic views 52 containing the migration information and the forecasted resource availabilities generated by resource forecaster 44. Referring to FIG. 2, a first illustrative electronic view 60 is shown. As depicted, view 60 includes a graphical user interface (GUI) 62 displaying forecasted resource availability information. GUI 62 may include, for example, a menu 64, a scroll bar 66, or any other GUI component known to one skilled in the art. As shown, view 60 sets forth past availabilities 74, current availabilities 76, and forecasted availabilities 78 for component parts 72 (i.e., resources). Information for each component 80, 90, 100 part may include a value for scheduled integration 84 representing resources currently scheduled for integration into the migration, projected integration 82 representing resources projected to be integrated into the migration but not yet scheduled for migration, and estimated integration 86 representing a use of resources not yet included in a migration database or migration schedule but which may become necessary and therefore affect forecasted availabilities.

Past availability values 74 are static values representing past forecast values. That is, past availability values 74 do not change and are provided to a user, if at all, to provide historical context for future forecasts. As shown in FIG. 2, past availability values 74 are for one month prior (CM−1) to the current month (CM). Similarly, view 60 provides current availability values 76, i.e., for the current month. Finally, view 60 provides forecasted availability values 78, i.e., for a future period one month from the current month (CM+1).

Referring more specifically to the values shown for part A 80, it can be seen that during the prior month (i.e., CM−1) 74, three units were scheduled 84A for inclusion in the IT migration, 13 units were projected 82A for inclusion in the IT migration, and zero units 86A were estimated for inclusion in the IT migration. Turning to the values of the current month (i.e., CM) 76, two units are scheduled 84B for inclusion, 10 units (i.e., 13 units projected less the three units scheduled for the prior month) are projected 82B for inclusion, and zero units are estimated 86B for inclusion in the IT migration. Finally, forecasted values 78 include two units scheduled 84C for inclusion, two units estimated 86C for inclusion, and 10 units (i.e., 10 units projected less two units scheduled for the current month plus the two units estimated for the forecast month) projected for inclusion in the IT migration. The estimated value 86C may be based on information available to a user but not yet included in a migration database or schedule and therefore not included in projected values provided by the database or schedule. Alternatively, estimated value 86C may be a value periodically incorporated into a forecast. View 60 may show estimated value 86C included in projected value 82C.

While shown in FIG. 2 as a forecast of availabilities for component parts 80, 90, 100, it should be understood that any device, component, individual, or resource involved in an IT migration may similarly be forecasted according to the present invention. Similarly, while shown as values corresponding to one-month intervals 70A, other intervals are possible, such as three-month intervals 70B, six-month intervals 70C, or any other interval or combination of intervals for which a forecast is desired. Alternatively, rather than providing a relative forecast period (i.e., a forecast period based upon a date the forecast is made), the present invention may provide a static forecast period (i.e., a forecast period for a specific date or range of dates not dependent upon the date the forecast is made).

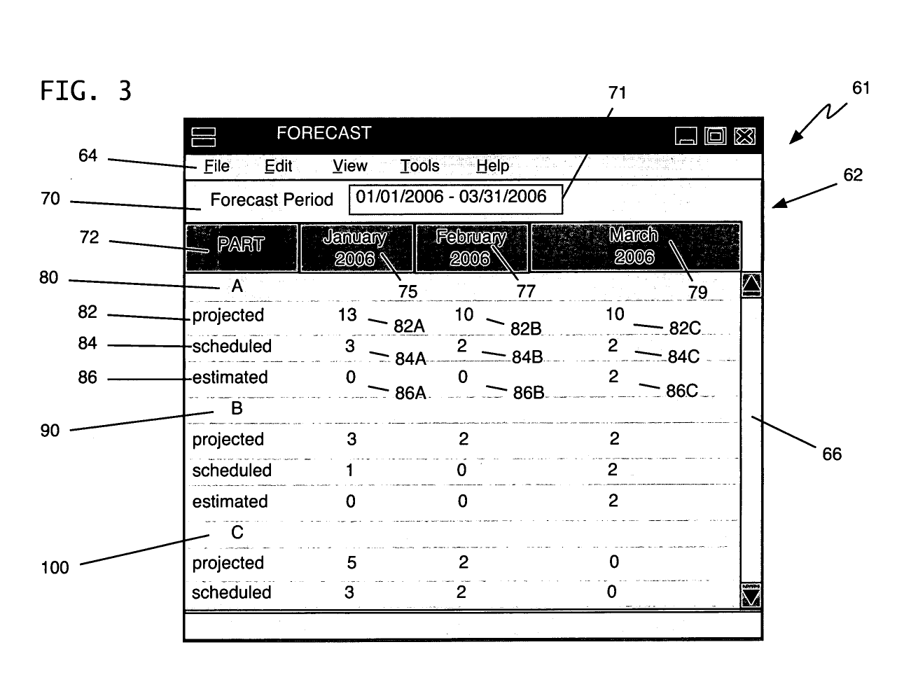

For example, FIG. 3 shows a second illustrative electronic view 61 displaying a static forecast. Here, a forecast period 70 is user-defined, the applicable period (i.e., 1 Jan. 2006 through 31 Mar. 2006) being entered by a user in a data field 71. Accordingly, forecast values are provided for specific months 75, 77, 79, although any unit of time (e.g., hours, days, weeks, years, etc.) may be similarly employed.

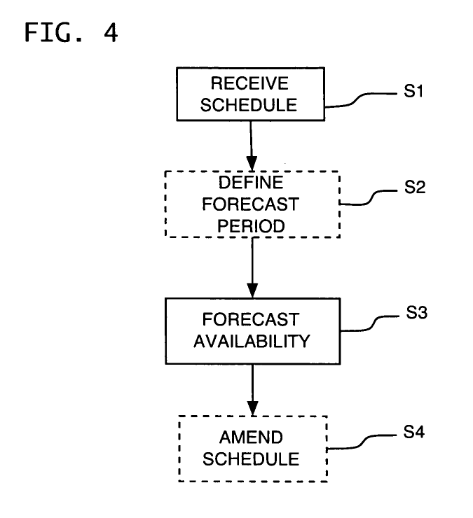

Referring now to FIG. 4, a method flow diagram according to the invention is shown. At step S1, a schedule is received. Although described above with respect to an IT migration schedule, any schedule for which a forecast of resource availability is desired may be used. Next, at optional step S2, a forecast period is defined by a user. If a relative forecast period or a pre-defined static forecast period is used, step S2 may be omitted. At step S3, a forecast of resource availability is made based on the received schedule and the applicable forecast period (e.g., user-defined, relative, or static). Finally, at optional step S4, the schedule may be amended based on the forecasted resource availability. For example, it may be advantageous to amend the future scheduled integration of a resource based upon a forecasted surplus or deficiency. As an example, referring again to FIG. 2, the number of units scheduled for integration during the following month 84C may be increased to “4” based, in part, on the estimated units forecasted 86C.

While shown and described herein as a method, system, and program product for forecasting resource availability in an IT migration, it is understood that the invention further provides various alternative embodiments. For example, in one embodiment, the invention provides a computer-readable/usable medium that includes computer program code to enable a computer infrastructure to forecast resource availability. To this extent, the computer-readable/usable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, could offer to forecast resource availabilities in an IT migration. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for forecasting resource availability in an IT migration. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A computer-implemented method for forecasting availability of a resource in an Information Technology (IT) migration, comprising:
receiving a schedule to perform the IT migration; and
forecasting a future availability of a resource during a forecast period.

2. The computer-implemented method of claim 1, wherein the schedule includes at least one of:
a scheduled integration of the resource;
a projected integration of the resource; and
an estimated integration of the resource.

3. The computer-implemented method of claim 1, wherein the forecast period is user-defined.

4. The computer-implemented method of claim 1, wherein the schedule comprises a database of migration information.

5. The computer-implemented method of claim 4, wherein the migration information includes at least one of the following: types of devices undergoing the IT migration, component parts, software running on the devices, locations of the devices, an availability of owners of the devices, available time windows, network connectivity for the devices, and environmental conditions for the devices.

6. The computer-implemented method of claim 1, further comprising the step of amending the schedule based on the forecasted future availability.

7. The computer implemented method of claim 6, wherein the amending step includes altering a scheduled integration of the resource.

8. A system for forecasting availability of a resource in an Information Technology (IT) migration, comprising:
means for receiving a schedule to perform the IT migration;
means for forecasting a future availability of a resource during a forecast period;
means for generating a view of a forecasted future availability; and
means for amending the schedule based on the forecasted future availability.

9. The system of claim 8, wherein the schedule includes at least one of:
a scheduled integration of the resource;
a projected integration of the resource; and
an estimated integration of the resource.

10. The system of claim 8, wherein the forecast period is user-defined.

11. The system of claim 8, wherein the schedule comprises a database of migration information.

12. The system of claim 11, wherein the migration information includes at least one of the following: types of devices undergoing the IT migration, component parts, software running on the devices, locations of the devices, an availability of owners of the devices, available time windows, network connectivity for the devices, and environmental conditions for the devices.

13. The system of claim 8, wherein the amending step includes altering a scheduled integration of the resource.

14. A program product stored on a computer-readable medium for forecasting availability of a resource in an Information Technology (IT) migration, the computer readable medium comprising program code for causing a computer system to perform the following steps:
receiving a schedule to perform the IT migration; and
forecasting a future availability of a resource during a forecast period.

15. The program product of claim 14, wherein the schedule includes at least one of:
a scheduled integration of the resource;
a projected integration of the resource; and
an estimated integration of the resource.

16. The program product of claim 14, wherein the forecast period is user-defined.

17. The program product of claim 14, wherein the schedule comprises a database of migration information, the migration information including at least one of the following: types of devices undergoing the IT migration, component parts, software running on the devices, locations of the devices, an availability of owners of the devices, available time windows, network connectivity for the devices, and environmental conditions for the devices.

18. The program product of claim 14, further comprising the step of amending the schedule based on the forecasted future availability.

19. The program product of claim 18, wherein the amending step includes altering a scheduled integration of the resource.

20. A method for deploying an application for forecasting availability of a resource in an Information Technology (IT) migration, comprising:
providing a computer infrastructure being operable to:
receive a schedule to perform the IT migration; and
forecast a future availability of a resource during a forecast period.
